(19) United States
(12) Patent Application Publication
(10) Pub. No.: US 2013/0071595 A1
(43) Pub. Date: Mar. 21, 2013

(54) Plant Label

(71) Applicant: Koon Wa Wu, New Territories (HK)

(72) Inventor: Koon Wa Wu, New Territories (HK)

(73) Assignee: Kon Dai (Far East) Packaging Co., Ltd., Kowloon (HK)

(21) Appl. No.: 13/368,292

(22) Filed: Feb. 7, 2012

(30) Foreign Application Priority Data
Sep. 15, 2011 (CN) 201110274571.0

(51) Int. Cl. G09F 3/02; G09F 3/10

(52) U.S. Cl. 428/40.1; 428/138

(57) ABSTRACT

The present invention discloses a plant label, which comprises a front layer, a middle layer and a bottom layer sequentially, and at least one kind of plant seeds is arranged between the middle layer and the bottom layer. The front layer is provided with at least one hole; and the middle layer 2 is a thin layer made of water-absorbent material or water-retention material, and is attached together with the front layer and the bottom layer respectively. The plant label according to the present invention is novel because plants may grow up through the label; what's more, the plant seeds in the label can germinate and then grow up at the location where the label is discarded, thus being environmentally friendly.

### CROSS-REFERENCE TO RELATED APPLICATION

This application claims foreign priority under 35 U.S.C. § 119 to Chinese Patent

Application no. 201110274571.0, filed in the People's Republic of China on Sep. 15, 2011, the entire contents of which are hereby incorporated by reference.

### FIELD OF THE INVENTION

The present invention relates to a label, and more particularly relates to a plant label.

### BACKGROUND OF THE INVENTION

Existing labels attached on products or packaging are generally used for decoration or logo. As the label together with the product or packaging is discarded, the label just becomes waste and cannot play any role.

### SUMMARY OF THE INVENTION

An objective of this invention is to provide a novel and environmentally friendly plant label aiming at overcoming the disadvantage that the label becomes waste and cannot play any role after being discarded in the prior art.

A technical solution utilized in this invention to solve its technical problem is as follows. According to an aspect, a plant label comprising a front layer, a middle layer and a bottom layer sequentially is provided, and at least one kind of plant seeds is arranged between the middle layer and the bottom layer; wherein,

the front layer is provided with at least one hole;

the middle layer is a thin layer made of water-absorbent material or water-retention material and is attached together with the front layer and the bottom layer respectively.

In the plant label according to the embodiment of the present invention, the upper surface of the bottom layer is attached with the edge of the middle layer, so that a sealed space for housing the plant seeds is formed between them.

In the plant label according to the embodiment of the present invention, the plant seeds are attached on the upper surface of the bottom layer which contacts with the middle layer by glue.

In the plant label according to the embodiment of the present invention, the plant seeds are concentrated at the location corresponding to the hole in the front layer.

In the plant label according to the embodiment of the present invention, the plant seeds comprise flowering plant seeds or vegetative plant seeds.

In the plant label according to the embodiment of the present invention, the hole in the front layer forms a decoration pattern or a logo pattern.

In the plant label according to the embodiment of the present invention, the water-retention materials comprise foam or sponge.

In the plant label according to the embodiment of the present invention, the water-absorbent materials comprise super absorbent polymers.

In the plant label according to the embodiment of the present invention, the middle layer is treated by nutrient solution.

In the plant label according to the embodiment of the present invention, the lower surface of the bottom layer is coated with glue and a removable additional layer is adhered thereon.

This invention has following advantageous effects: as the front layer is provided with holes, the plant seeds arranged between the middle layer and the bottom layer can germinate and grow up through the holes when they absorb water and/or nutrient, which may make the label very novel. Moreover, when the plant label together with the product or packaging is discarded, the discarded label is still available and environmentally friendly since the plant seeds in the plant label can scatter onto the discarded location and further germinate. For example, according to different types of the plant seeds, they can grow into mosquito repellant plants or animal foods.

### BRIEF DESCRIPTION OF THE DRAWINGS

The present invention is further described with reference to the accompanying drawings and embodiments. In the figures:

FIG. 1 is a structure schematic view of a plant label according to the embodiment of the present invention.

### DETAILED DESCRIPTION OF THE PREFERRED EMBODIMENT

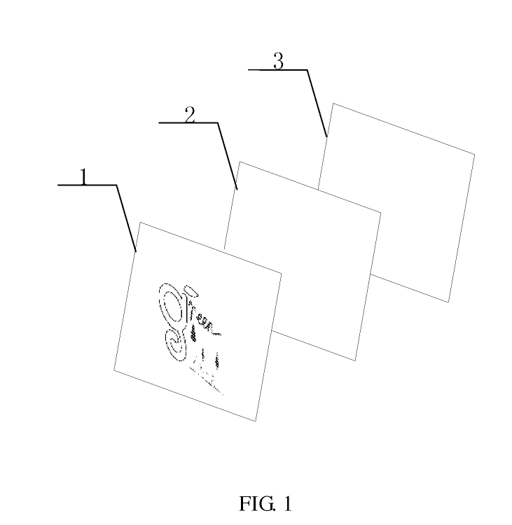

Hereinafter, embodiments of the present invention will be described in detail with reference to the accompanying drawings. It should be noted that the specific embodiments described herein are just used for illustrating the present invention instead of limiting it. FIG. 1 shows a structure schematic view of a plant label according to the embodiment of the present invention. As shown in FIG. 1, the plant label according to the embodiment of the present invention comprises a multi-layer structure. The multi-layer structure comprises a front layer 1, a middle layer 2 and a bottom layer 3 sequentially. Wherein, at least one kind of plant seeds is arranged between the middle layer 2 and the bottom layer 3. A wide variety of seeds can be used here including flowering plant seeds, vegetative plant seeds and tree seeds.

The front layer 1 is made of hard material, such as hard paper material or hard plastic film material. The biodegradable paper material is preferred since the plant seeds therein still have an opportunity to grow up even after the label is discarded, thus being more environmentally friendly. Moreover, the front layer 1 is provided with at least one hole. On one hand, the plant seeds may contact with air and water through the middle layer 2 and the holes; on the other hand, the holes may be designed as a variety of shapes, such as round, square, polygon, or a combination thereof for decoration, or else as a logo of a product or a company for identification. The holes in the front layer 1 of the plant label as shown in FIG. 1 is designed as the letter “g”. The holes may form a pattern for decoration or logo alone, or form a pattern by combinations. Moreover, when geminating, the plant seeds may grow up through the holes. As for decoration or logo, the front layer 1 may be designed in a variety of colors comprising red, and green and so on. The front layer 1 as shown in FIG. 1 is designed in white. Besides, the front layer 1 is also provided with varieties of patterns or words. It should be understood that the above examples are non-limiting, while various changes, substitutions and alterations can be made hereto without departing from the spirit and scope of the invention.

The middle layer 2 is a thin layer made of water-absorbent material or water-retention material, and is attached with the front layer 1 by glue while the position thereof corresponding to the holes in the front layer 1 is not covered with glue. Of course, the middle layer 2 may be combined with the front layer 1 in other ways, such as by stitching. In one aspect, the middle layer 2 is used to fix the plant seeds positioned between the middle layer 2 and the bottom layer 3 so as to prevent the plant seeds from falling off the label. In another aspect, the middle layer 2 may facilitate the growth of the plant seeds. As the middle layer 2 is made of water-retention material, such as porous foam or sponge, when the plant label is sprayed by water directly from outside or is positioned in a high humidity environment, the middle layer 2 is able to retain water so as to promote the plant growth. As the middle layer 2 is made of water-absorbent material, such as super absorbent polymers (for example, polyacrylate material), the middle layer 2 is able to absorb the moisture in the air by itself. In order to make the plant grow better, nutrient is needed for the plant seeds. The middle layer 2 may thus be treated by nutrient solution. For example, the middle layer 2 can be sprayed by nutrient solution or soaked in nutrient solution and then dried, so as to make the middle layer 2 provided with nutrients. In use, the nutrients contained in the middle layer 2 may be dissolved in water to provide nutrients for plant growth. The nutrient solution may be prepared according to the formula recorded in “Modern Practical Soilless Cultivation Techniques” or be purchased from the market directly, such as nutrient solution series band of Bird of Paradise. Moreover, the middle layer 2 is so thin that plants can grow up through it after germination.

The bottom layer 3 is made of hard material, such as hard paper material or hard plastic film material. Wherein, the biodegradable paper material is preferred. After the label is discarded, the plant seeds therein still have an opportunity to grow up, thus being more environmentally friendly. The edge of the upper surface of the bottom layer 3 which contacts the middle layer 2 is coated with glue, so that the bottom layer 3 can be fixed onto the middle layer 2 and a sealed space can be formed between the bottom layer 3 and the middle layer 2. The plant seeds may be arranged in the sealed space to prevent themselves from falling off the label. In addition, the plant seeds may be attached on the upper surface of the bottom layer 3 which contacts the middle layer 2 by glue. When the bottom layer 3 and the middle layer 2 are fixed together (for example, by glue), the plant seeds may be then fixed between them without falling off. Preferably, the plant seeds may be concentrated at the location corresponding to the holes in the front layer 1 so as to facilitate the plant seeds to grow up through the holes. Moreover, the lower surface of the bottom layer 3 opposite to the upper surface is coated with glue and a removable additional layer which is made of smooth hard plastic film or glossy paper is adhered thereon. In use, once the additional layer is removed, the label may stick onto any desired location.

The plant label according to the embodiment of the present invention may be attached onto the product or packaging directly, or be used in combination with Radio Frequency Identification (RFID). The descriptions above have shown that, in the use of the plant label, the plant seeds positioned between the middle layer and the bottom layer may germinate and then grow up through the holes, so that it is not only beautiful but also novel and unique when the label is used for logo. When the label is discarded, as the label is made of environmentally friendly degradable materials as far as possible, the plant seeds are easy to grow into plants at the place where the label is discarded. So, instead of just becoming waste, the discarded label is available and environmentally friendly. For example, according to different types of the plant seeds, they can grow into mosquito repellant plants or animal foods.

It should be understood for a person skilled in the art that various change and alterations can be made based on the above description without departing from the spirit and scope of the invention as described by the appended claims.

I claim:

1. A plant label comprising: a front layer, a middle layer and a bottom layer sequentially, and at least one kind of plant seeds arranged between said middle layer and said bottom layer; wherein,
said front layer is provided with at least one hole;
said middle layer is a thin layer made of water-absorbent material or water-retention material, and is attached together with said front layer and said bottom layer respectively.

2. A plant label according to claim 1, wherein an upper surface of said bottom layer is attached with an edge of said middle layer, so that a sealed space for housing said plant seeds is formed between the middle layer and the bottom layer.

3. A plant label according to claim 1, wherein said plant seeds are attached to an upper surface of said bottom layer, the bottom layer contacts with said middle layer by glue.

4. A plant label according to claim 2, wherein said plant seeds are concentrated at a location corresponding to said at least one hole in said front layer.

5. A plant label according to claim 3, wherein said plant seeds are concentrated at a location corresponding to said at least one hole in said front layer.

6. A plant label according to claim 1, wherein said plant seeds comprise flowering plant seeds or vegetative plant seeds.

7. A plant label according to claim 1, wherein said at least one hole in said front layer forms a decorative pattern or a logo pattern.

8. A plant label according to claim 1, wherein said water-retention material comprises a foam or a sponge.

9. A plant label according to claim 1, wherein said water-absorbent material comprises super absorbent polymers.

10. A plant label according to claim 1, wherein said middle layer is treated by a nutrient solution.

11. A plant label according to claim 1, wherein a lower surface of said bottom layer is coated with glue and a removable additional layer is adhered thereon.
